(19) United States
(12) Patent Application Publication
(10) Pub. No.: US 2004/0216375 A1
(43) Pub. Date: Nov. 4, 2004

(54) Plant container

(76) Inventor: Rufus M. Holloway Jr, Orlando, FL (US)

Correspondence Address: David G Maire, Beusse Brownlee Wolter Mora & Maire, Suite 2500, 390 North Orange Avenue, Orlando, FL, 32801, US

(21) Appl. No.: 10/493,647

(22) PCT Filed: Oct. 24, 2002
(86) PCT No.: PCT/US02/34035

Related U.S. Application Data
(60) Provisional application No. 60/336,551, filed on Oct. 25, 2001.

(51) Int. Cl. A01G 9/02

(52) U.S. Cl. 47/65.5

(57) ABSTRACT

A plant container (50) having an inner member (52) containing a volume of earthen material (54) and an outer member (56) of IR reflective material. The inner member and outer member may be combined into a composite sheet of material (18) having an inner layer of material (28) providing strength and an outer layer of material (26) providing heat reflection and UV protection. The outer layer of material may be a white plastic containing titanium dioxide while the inner layer of material may be a less expensive material. In one embodiment, a prior art IR-absorbing black plastic or clay container is wrapped with a sheet of composite plastic material (18) having a white titanium dioxide-containing outer layer 26.

### FIELD OF THE INVENTION

This invention relates generally to the field of horticulture and more specifically to containers for growing plants.

### BACKGROUND OF THE INVENTION

Containers or pots of many types are well known in the art of horticulture for containing a volume of earthen material for growing a plant. Containers may be made of metal, clay, ceramic, wood, etc. and they are commonly made of a plastic material. The container confines the root ball and for allows the plant to be moved without digging. It may also serve an ornamental purpose. Plant nurseries and tree farms may grow potted plants on a man-made flood plane that is selectively flooded to provide water to the root ball through holes formed in the container. Such systems are described in U.S. Pat. Nos. 5,993,111 and 6,109,827.

The exposure of a container to sunshine will result in the absorption of radiant energy by the container material. Plastic containers that are used in an outdoor environment must contain an additive that will protect the plastic material from degradation caused by ultraviolet radiation (UV). Carbon black is often selected for this purpose because it is relatively inexpensive. The absorbed sunlight will also result in an increase in the temperature of the container and its contained earthen material and root ball. For many commercially important plants, a root temperature of more than about 110-115° Fahrenheit may result in death or damage to the plant. Accordingly, in warm weather environments it is often preferable to use a white or light-colored container rather than a dark-colored container in order to minimize the temperature rise due to the absorbed radiant energy. Carbon black cannot be used to provide UV protection for a white plastic container because it darkens the plastic matrix material. Titanium dioxide (TiO₂) is most commonly used to provide UV protection for a white or light-colored plastic container. Unfortunately, titanium dioxide is much more expensive than carbon black so white plastic containers are much more expensive than dark plastic containers.

### SUMMARY OF THE INVENTION

Thus, a plant container suitable for outdoor use but having a reduced cost is desired. Furthermore, a reduced-cost plant container having a white exterior surface is desired.

A plant container is described herein as being characterized by a wall member comprising a composite material having an outer layer of material disposed over an inner layer of material different than the outer layer of material. The outer layer of material may be a UV stabilized plastic material and the inner layer of material may be a plastic material that is not UV stabilized. The outer layer of material may be a layer of IR reflective UV stabilized plastic material containing titanium dioxide. The inner layer of material may contain no titanium dioxide. The outer layer of material may be white and the inner layer of material may be black.

A plant container is described herein as being characterized by an inner member defining a volume for containing an earthen material for growing a plant; and an outer member covering an outer surface of the inner member, the outer member comprising a material different than the inner member.

A plant container having an inner member defining a volume for containing an earthen material for growing a plant is described herein as being characterized by an outer layer of IR reflective material being disposed about the inner member as a heat shield.

### BRIEF DESCRIPTION OF THE DRAWINGS

These and other advantages of the invention will be more apparent from the following description in view of the drawings that show:

FIG. 1 is a plan view of a plant container for growing a plant.

FIG. 2 is a top view of the plant container of FIG. 1.

FIG. 3 is a top view of a sheet of material that is used to form the plant container of FIG. 1.

FIG. 4 is a partial cross-section view of the composite material used to form the sheet of material of FIG. 3.

FIG. 5 is a top view of a plant container having an inner member retaining a volume of earthen material and an outer heat shield member.

### DETAILED DESCRIPTION OF THE INVENTION

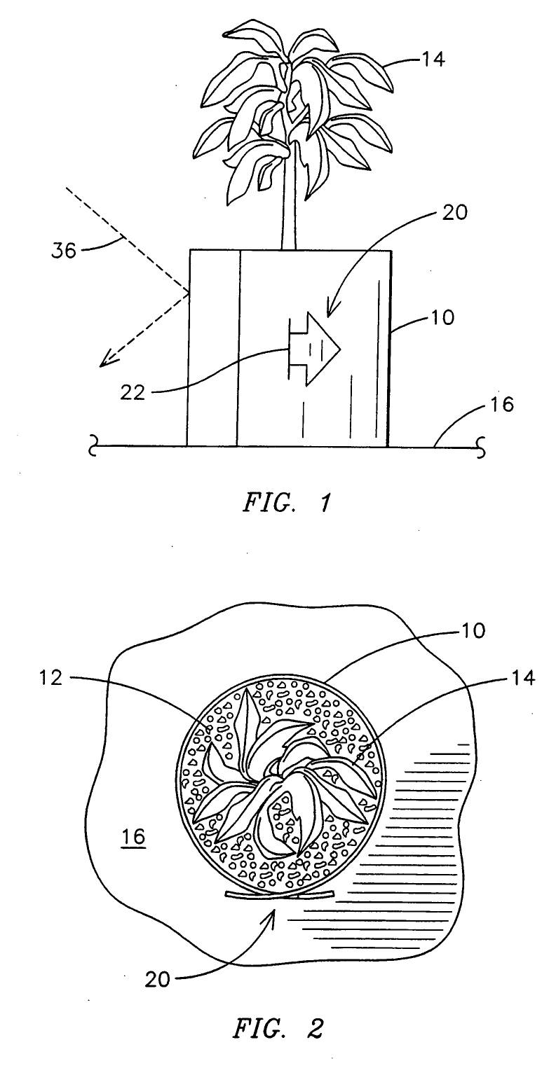

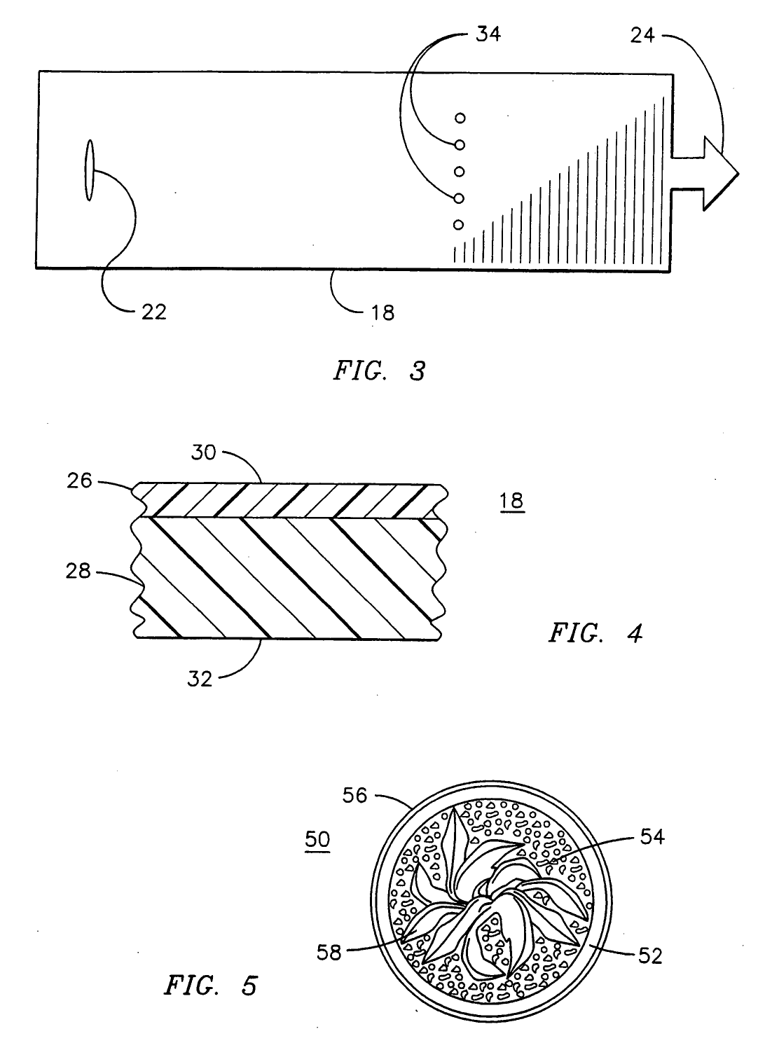

A plant container 10 is illustrated in FIGS. 1 and 2 as it may be used to support a volume of earthen material 12 for growing a plant 14 on a flood plain 16 in a nursery or tree farm. The plant container wall member 18 may be formed from a sheet of material, as illustrated in FIG. 3, which has sufficient flexibility to be bent into a generally tubular shape to form the sides of the plant container 10. A bottom of the plant container 10 (not shown) may be joined to or may be formed to be integral with the sides of the container 10. Alternatively, the embodiment of FIGS. 1-3 utilizes the surface of the flood plain 16 to further confine the volume of earthen material 14 and roots of plant 14 in lieu of a container bottom. The plant container 10 is supported in its tubular shape by a connector 20, which as can be best seen in FIG. 3, includes a slot 22 formed in the sheet of material 18 and an opposed end 24 of the wall member 18 that is shaped to extend through the slot while resisting withdrawal from the slot 22. Other types of connector 20 may be used; for example, mating angled slots formed on opposed ends of the wall member 18, one or more clamps, staples, glue, welded material, or simply a post or fixture around which opposed ends of the sheet of material are wrapped.

The wall member 18 may be any thin, bendable material, such as thin metal, wood or preferably plastic such as a polyethylene or polypropylene or other such material. The term plastic is used herein to include any of the various known complex organic compounds produced by polymerization and capable of being molded, extruded, cast into various shapes and films, or drawn into filaments and used as textile fibers. One such plastic material is available from GSE Lining Technology Inc. of Houston, Tex., and has the useful characteristic of being white on one side and black on the opposite side, and being resistive to degradation in outdoor environments. The material may be 40-80 mils thick, for example. In warm environments, the wall member 18 may be assembled to have the white side outward, in order to reflect sunlight, thereby keeping the plant roots at a relatively cooler temperature. In direct sunlight in a warm environment, a white outer surface may keep the enclosed root ball about 25-30° F. cooler than a dark outer surface. The reflected sunlight may further improve the growth of the plant growing in the container 10 or a neighboring plant by being absorbed into the leaves of the plant rather than into the container. In a cool environment, the wall member 18 may be assembled to have the black side outward in order to absorb sunlight to further warm the plant roots.

FIG. 4 illustrates a partial cross-section of the sheet of material forming wall member 18 showing it to have a composite construction with an outer layer of material 26 disposed on an inner layer of material 28. The outer layer of material 26 is a different material than the inner layer of material 28. Advantageously, the outer layer of material 26 may be a plastic material such as polyethylene, polypropylene or polyethylene blend or other polyolefin material that is ultraviolet (UV) stabilized using titanium dioxide or other material that does not increase the tendency of the material to absorb infrared (IR) heat energy and visible light. The inner layer of material 28 need not be UV stabilized although it may be if so desired. The dopant used to UV stabilize the inner layer of material 28 may be a different material than the dopant used to UV stabilize the outer layer of material 26. In one embodiment, outer layer of material 28 is a white plastic material approximately 3-4 mils thick containing titanium dioxide as a UV stabilizer while the inner layer of material 28 is a black plastic material 36-37 mils thick containing carbon black as a UV stabilizer but containing no titanium dioxide. The inner= layer 28 provide a degree of strength necessary to confine the enclosed volume of earthen material 12 while the outer layer 26 reflects heat and protects against the harmful effects of UV radiation. In this manner, the composite sheet of material used for wall member 18 is suitable for outdoor use because it is UV stabilized and it has a heat/IR/visible light-reflective white outer surface 30. This allows container 10 to be less expensive than prior art containers because it contains a reduced amount of expensive titanium dioxide material when compared to single-material all-white prior art plastic containers. Furthermore, the plant container 10 may be formed with the composite sheet of material forming wall member 18 having either the white or the black side facing outward for warm or cool environments respectively.

The sheet of material used as wall member 18 may be used as a heat shield when wrapped around another existing container. In this application, the light colored surface 30 would be facing outward. Alternatively, composite sheet of material 18 may be wrapped around an existing light-colored IR reflecting container with the dark side 32 facing outward to promote heating of the plant roots in a cold environment.

The diameter of the plant container 10 may be fixed by welding or other type of fastener 20 once assembled. Because the wall member 18 is relatively flexible, the container can be folded flat for shipment and storage. Preferably, the unassembled wall members 18 with or without a bottom member can be shipped and stored in a completely flat condition, then easily assembled in the field just prior to use.

Holes 34 may be formed in the wall member 18 for ventilating the plant roots. The holes may be formed in a predetermined pattern, such as to form words, figures, or a trademark for advertising purposes. No such holes may be desired on the bottom member in order to prevent the roots from penetrating into the underlying ground. The plastic may be perforated to promote root pruning or to increase the ease of flood irrigation or to promote container cooling.

The plant container 10 may be constructed of various composite materials and may be of any color on either or both surfaces. The inner surface may be a material that is root retardant to prevent root circling. It may also be constructed with a rough or gritty surface. The sides and bottom of the container may be formed as an integral unit such as by casting, extruding or molding or other process known in the art. The described container is lightweight, easy to ship, store and assemble, collapsible, adjustable, reversible, inexpensive, and provides a cool or warm environment for the plant roots. The outer layer 26 is disposed over the inner layer 28 and it may be integrally bonded across its entire surface to the inner layer 28. Alternatively, the two layers may be bonded only at selected areas or they may not be bonded together at all, but rather be held together by other means.

Materials that are exposed to sunlight may degrade as a result of damage caused by the ultraviolet radiation (UV). Known plastic outdoor plant containers are UV-stabilized with carbon black. Carbon black is also a strong absorber of infrared (IR) and visible light energy. The use of such materials can be detrimental to plant roots, particularly in warm climates, due to the heating of the container as a result of the absorbed electromagnetic energy. The present invention is a plant container 10 that is constructed of a composite material that is UV-stabilized and IR reflective on its outer surface 30. The dopant that provides the UV-stability may also provide the reflection of IR and/or visible light. The container 10 may have a colorant added for aesthetic purposes, and the IR-reflective substance may be part of the colorant.

Plastics containing little or no carbon black are known, and at least some such materials may also be IR-reflective. Such materials have been used as refuse dump liners and aquaculture liners. The present invention provides a plant container 10 formed of a composite material that is UV-stabilized and IR-reflective, at least on its outer surface 30, and is perhaps also white to maximize the reflection of visible light. Such a container 10 will reflect a majority of the incident heat-generating radiation 36, thereby enhancing root growth by keeping the container cooler, while maintaining plastic stability in direct UV light exposure.

FIG. 5 illustrates a plant container having an inner member 52 for containing a volume of earthen material 54 and an outer member 56 wrapped around the inner member 52. The outer member 56 is a different material than the inner member 52. In one embodiment, the inner member 52 is a prior art clay or plastic plant container and the outer member 56 is a heat shield made from a material selected for its ability to reflect infrared radiation, thereby keeping the roots of plant 58 at a reduced temperature when exposed to sunlight in a warm environment. Since the outer member 56 will be exposed to sunlight, it may be made from a material that is UV stabilized. The inner member 52 may or may not be UV stabilized, and it may provide 100% of the mechanical force necessary to contain the earthen material 54. The outer member 56 may be a single material throughout its thickness, such as a single layer of aluminum foil or other IR reflective material, or it may be a composite material, such as the composite material 18 illustrated in FIG. 4, with only an outer portion having the desired IR-reflecting and/or UV-stabilized property. The outer member 56 may be simply wrapped around the inner member 52 or it may be affixed to the inner member 52 such as by mechanical fasteners or bonding such as with glue or hot plastic welding. In this manner, an existing IR-absorbing black plastic plant container made with relatively inexpensive carbon black UV-stabilizing material may be improved to function as an IR-reflecting, UV-stabilized plant container without the need to replace the entire container with expensive titanium dioxide-containing plastic material.

The preferred embodiments of the present invention have been described herein by way of example only. Numerous variations, changes and substitutions will occur to those skilled in the art without departing from the invention herein. Accordingly, it is intended that the invention be limited only by the scope of the appended claims.

1-8. (cancelled.)

9. A plant container having a wall member formed to support a volume of earthen material, the plant container characterized by the wall member comprising a composite material having an outer layer of material disposed over an inner layer of material different than the outer layer of material, further characterized by the outer layer of material being a plastic that is UV stabilized by a first dopant and the inner layer of material being a plastic that is UV stabilized by a second dopant different than the first dopant.

10-20. (cancelled).

21. The plant container of claim 9, further characterized by the outer layer of material comprising titanium dioxide and the inner layer of material comprising carbon black.

22. The plant container of claim 9, further characterized by the outer layer of material comprising titanium dioxide and the inner layer of material comprising no titanium dioxide.

23. A plant container comprising:
an inner member for containing a volume of earthen material; and
an outer member comprising a UV stabilized composite material wrapped around the inner member;
wherein the outer member further comprises an outer layer of material comprising a plastic that is UV stabilized by a first dopant and an inner layer of material comprising a plastic that is UV stabilized by a second dopant different than the first dopant.

24. The plant container of claim 23, wherein the outer layer of material comprises titanium dioxide and the inner layer of material comprises carbon black.

25. The plant container of claim 23, wherein the outer layer of material comprises titanium dioxide and the inner layer of material comprises no titanium dioxide.

26. A method of affecting the temperature of roots of a plant being held in a plant container exposed to sunlight, the method comprising wrapping an outer member of composite material around the plant container, the composite member comprising an outer layer of plastic that is UV stabilized by a first dopant and an inner layer of material of plastic that is UV stabilized by a second dopant different than the first dopant.

27. The method of claim 26, further comprising selecting the outer layer to comprise titanium dioxide so that the outer layer is IR-reflecting to affect a reduction of the temperature of the roots in a warm environment.
